(19) United States
(12) Patent Application Publication
(10) Pub. No.: US 2026/0221057 A1
(43) Pub. Date: Jul. 30, 2026

(54) SHEET ARTICLE WITH EXPANDABLE CUTS

(71) Applicant: Bedford Industries, Inc., Worthington, MN (US)

(72) Inventors: Jay A. Milbrandt, Worthington, MN (US); Kristy Thurmer, Jackson, MN (US)

(21) Appl. No.: 19/145,369

(22) PCT Filed: Jan. 31, 2024
(86) PCT No.: PCT/US2024/013702

§ 371 Date: Jul. 2, 2025

Related U.S. Application Data
(60) Provisional application No. 63/483,338, filed on Feb. 6, 2023.
(60) Provisional application No. 63/579,335, filed on Aug. 29, 2023.

(51) Int. Cl. G09F 3/04; G09F 3/02

(52) U.S. Cl. CPC G09F 3/04; G09F 3/02; G09F 2003/0269

(57) ABSTRACT

An article is formed of a sheet material and comprises a tag and a loop surrounding an aperture. The loop is connected to the tag and comprises a perimeter edge and an aperture edge. The loop comprises an expandable portion that comprises a plurality of perimeter cuts and a plurality of aperture cuts. Each of the perimeter cuts extends to the perimeter edge, and each of the aperture cuts extends to the aperture edge.

### BACKGROUND

There are many forms of labeling arrangements that use bands that extend around the item to be labeled, such as merchandise or produce items. Sometimes the heretofore known bands have elastic sections united to non-elastic sections, and sometimes they are endless elastic bands commonly called rubber bands.

For example, U.S. Pat. No. 2,516,292 (Bennett) teaches a preformed labeling article of elastic and non-elastic sections for holding bananas constantly under tension as they shrink. The ends of the elastic and non-elastic sections of the band are overlapped and adhesively or otherwise bonded together. U.S. Pat. No. 5,733,652 (Stowman et al.) discusses banding of merchandise by a technique involving in situ bonding of the ends of a strip of elastic material with or without an interposed separate strip of material that is not necessarily elastic. When either a preformed band of bonded sections or an in situ formed band of bonded sections is stretched about merchandise, it exerts a compressive force on the merchandise. One problem presented by these approaches is the questionable reliability of machine-readable information (such as a UPC bar code or QR code, for example) on stretched (and therefore deformed) bands encircling merchandise.

In some labeling arrangements, endless bands of rubber (commonly called rubber bands) are used, as in teachings of U.S. Pat. No. 5,617,656 (Ludlow et al.); U.S. Pat. No. 5,697,177 (Ludlow et al.); and U.S. Pat. No. 6,058,639 (Tinklenberg), and a labeling tag is attached to each band of rubber. This approach is inefficient from a labor and assembly standpoint, although it has been one of the more popular approaches in the past because the tag (preferably non-stretchable) is distinct from the rubber band and can carry reliable (undeformed) visible and machine-readable information that is easy to review and handle at checkout (including machine scanning of the label information).

A known merchandise marking article capable of single-step application to achieve simultaneous banding and scan-reliable bar-coding of merchandise is described in U.S. Pat. No. 5,778,583 (Larsen), where the tag is attached to the rubber band by encircling a section of the tag about the rubber band prior to the time the rubber band is fastened in banding condition about merchandise. However, economy is not a hallmark for the manufacture of this prior art article.

### SUMMARY

In one aspect, an article is formed of a sheet material and comprises a tag and a loop surrounding an aperture. The loop is connected to the tag and comprises a perimeter edge and an aperture edge. The loop comprises an expandable portion that comprises a plurality of perimeter cuts and a plurality of aperture cuts. Each of the perimeter cuts extends to the perimeter edge, and each of the aperture cuts extends to the aperture edge.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures (designated with common reference numbers) throughout the several embodiments, unless otherwise specified.

Several embodiments of an article 20 are illustrated, summarized as follows:

A first embodiment of an article, designated as article 20a, is configured as a band, illustrated in FIGS. 1A and 2, having two relatively long expandable portions.

A second embodiment of an article, designated as article 20b, is configured as a band, illustrated in FIGS. 1B, 3 and 5, having two relatively short expandable portions.

A third embodiment of an article, designated as article 20c, is configured as a band, illustrated in FIG. 3, having three relatively short expandable portions.

A fourth embodiment of an article, designated as article 20d, is configured as a tag, illustrated in FIGS. 1C and 11-12B, having a rectangular tag and an oval loop w/one top expandable portion.

A fifth embodiment of an article, designated as article 20e, is configured as a tag, illustrated in FIGS. 1D, 13 and 14, having a rectangular tag with rounded corners and a circular loop with two side expandable portions.

A sixth embodiment of an article, designated as article 20f, is configured as a band, illustrated in FIGS. 7-10B, having a single long rear expandable portion.

A seventh embodiment of an article, designated as article 20g, is configured as a tag, illustrated in FIG. 15, having a rectangular tag with rounded corners and a circular loop with one top expandable portion and two side expandable portions.

An eight embodiment of an article, designated as article 20h, is configured as a tag, illustrated in FIG. 16, having a rectangular tag and a circular loop with two rear expandable portions.

An ninth embodiment of an article, designated as article 20i, is configured as a tag, illustrated in FIGS. 17 and 18, having a circular tag and a circular loop with two rear expandable portions.

FIG. 1A is a view of the first exemplary article with expandable cuts.

FIG. 1B is a view of the second exemplary article with expandable cuts.

FIG. 1C is a front view of the fourth exemplary article with expandable cuts.

FIG. 1D is a front view of the fifth exemplary article with expandable cuts.

FIG. 2 is a plan view of the first exemplary article.

FIG. 3 is a plan view of the second exemplary article.

FIG. 4 is a plan view of a third exemplary article.

FIG. 5 shows the second exemplary article formed into a loop by attaching its two ends to each other.

FIG. 6 is a partial plan view of an exemplary joint of two ends of a strip or band article, formed into a loop.

FIG. 7 is a top perspective view of a first part of a sixth exemplary article.

FIG. 8 is a plan view of a second part of the sixth exemplary article.

FIG. 9 is a top perspective view of an assembled sixth exemplary article.

FIG. 10A is a side perspective view of the sixth exemplary article placed on a product, configured as a bunch of bananas.

FIG. 10B is a rear perspective view of the sixth exemplary article placed on the bunch of bananas.

FIG. 11 is a plan view of the fourth exemplary article.

FIG. 12A is a front perspective view of the fourth exemplary article placed on a portion of a product, illustrated as the neck of a bottle.

FIG. 12B is a rear perspective view of the article and product of FIG. 12A.

FIG. 13 is a plan view of the fifth exemplary article.

FIG. 14 is a side perspective view of the fifth exemplary article disposed on a product, illustrated as the neck of a bottle.

FIG. 15 is a plan view of a seventh exemplary article.

FIG. 16 is a plan view of an eighth exemplary article.

FIG. 17 is a plan view of a ninth exemplary article.

FIG. 18 is a side perspective view of the ninth exemplary article placed on a product.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “side,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

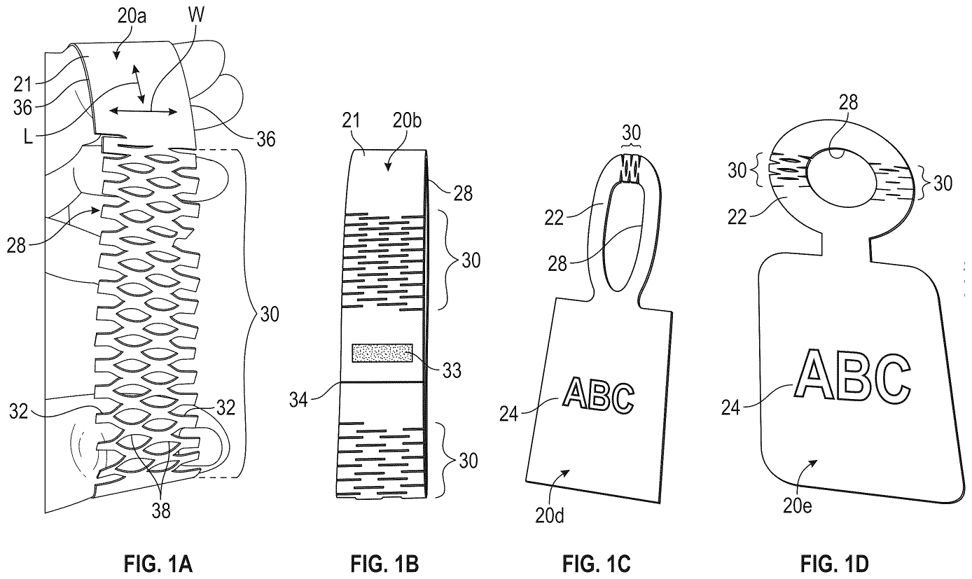

This disclosure relates to structures of sheet articles 20 and methods for their formation and use, such as for labeling products. FIGS. 1A-1D show several exemplary embodiments of an article 20 as described in this disclosure. While article 20 can take various forms, separate embodiments of which are designated with a lowercase letter as in 20a, 20b, 20c, 20d, 20e, 20f, 20g, 20h and 20i, these described embodiments are merely illustrative, and the features of the article 20 can be provided in other forms consistent with this disclosure. Reference numeral 20 is used to refer to the articles in general, wherein the use of reference numeral 20 with a lowercase letter may refer to a particular embodiment of a labeling article. The articles 20 have various features and structural characteristics in common, such as being formed of a unitary piece of sheet material shaped and cut into particular configurations (or construction of such a loop of material) to provide functions and benefits as described herein.

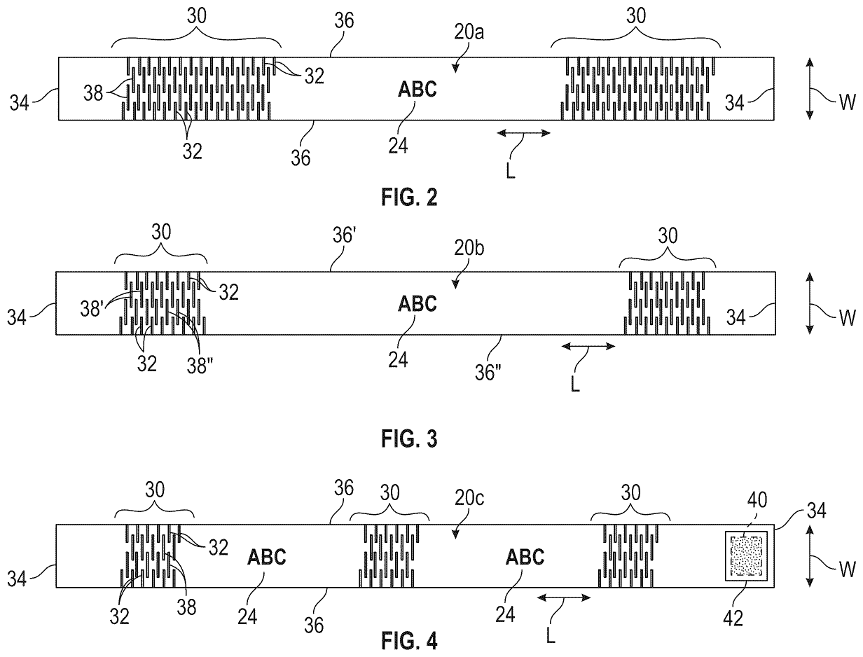

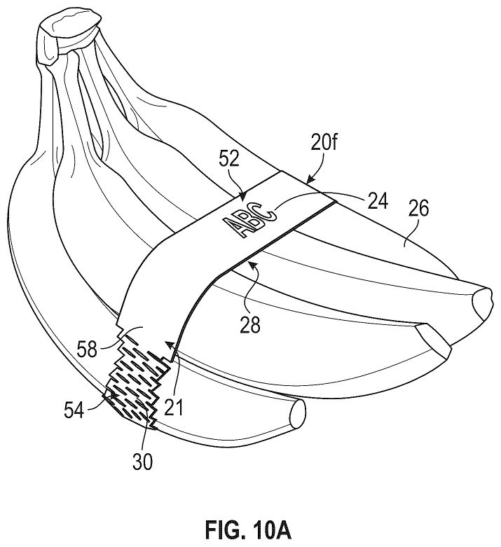

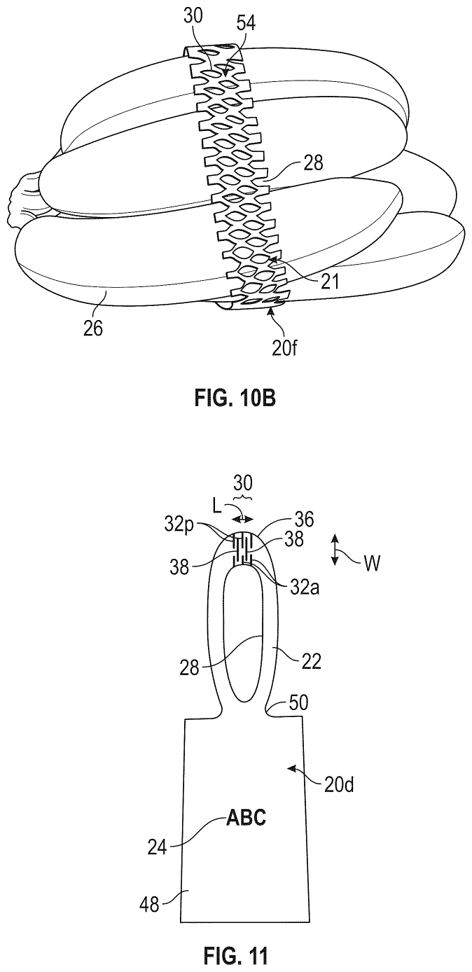

As shown in FIGS. 1A and 1B, articles 20a and 20b are formed of a flat strip of sheet material (plan views of which are shown in FIGS. 2 and 3) that is formed into a loop. In this description, “flat” means that the material is provided in sheet or web form having a primary two-dimensional structure. The sheet has some thickness but generally parallel first and second major surfaces. The major (front and rear) surfaces may be textured but generally do not have significant structures protruding therefrom. The sheet is generally flexible, so it can be floppy and not always provided in a planar state. Articles 20a, 20b, 20c, 20f generally have an elongated strip, band, or flattened ring configuration and can be used as shown in FIGS. 10A and 10B, disposed around a portion of a product 26. In one method of use, an article 20 is wrapped around a portion of a product 26, and opposite ends of the strip (see FIGS. 2-6: proximate opposite end edges 34) are joined together to form a loop strip 21 around the product 26, which is held in aperture 28 of the loop strip 21. In another method of use, the article is already formed during manufacture in a loop strip 21 (see FIGS. 1A and 9), and aperture 28 is expanded for insertion of a portion of a product 26. FIG. 1A shows band article 20a with the digits of a user's hand inserted into aperture 28 to expand a circumference of the loop 21 by increasing a length of expandable portion 30 in direction L. In contrast, in articles 20d, 20e, 20g, 20h and 20i, product receiving aperture 28 of a loop 22 is provided as a hole that is cut or otherwise disposed into and through the sheet material.

In some embodiments, article 20 is provided with indicia 24 (for example printed information readable by human or machine). While textual indicia 24 are illustrated in some embodiments, graphics and other information such as scannable UPC (Universal Product Code) or QR (Quick Response) codes can be printed or other indicia otherwise provided (such as by embossing Braille text, for example) on a surface of article 20. The sheet material from which article 20 is formed (i.e., cut) is generally flat and includes two major surfaces, generally referred to as a front surface and a back surface. The indicia 24 can be provided on either or both of the major surfaces, and different indicia may be provided on a first surface relative to a second surface. Moreover, the indicia on the front and rear (or on the outward facing and inward facing) surfaces of the article 20 need not be identical.

While article 20 is formed in exemplary embodiments of a sheet material, the sheet material itself may include multiple layers, different colors or other properties of a front surface relative to a rear surface, and other variations. The terms “front” surface and a “rear” surface are used for purposes of describing opposite major surfaces of the sheet material. However, it is understood that either surface of the article 20 may face outward toward a viewer when applied to product 26, and either or both surfaces of the article 20 can carry visual or otherwise detectable indicia 24. Surfaces of article 20 may be treated to accept printing thereon (or to accept writing ink or another medium thereon) or to enhance the visibility of information disposed thereon (e.g., such as by applying a coating thereto).

In some exemplary embodiments, the article 20 is primarily formed from a sheet material having a uniform composition. A suitable sheet material is substantially inextensible (i.e., non-stretchable) so that indicia 24 provided thereon does not become distorted or deformed during handling and use of article 20. To provide for flexibility in a dimension of aperture 28, each article 20 is provided with one or more expandable portions 30. A portion beyond the expandable portion is considered to be a major portion of the article 20; in an exemplary embodiment, a major portion does not have cuts through the sheet material (at least not cuts made for the purpose of creating an expandable portion of the article 20). In an exemplary embodiment, an aggregate surface area of a major portion(s) not having cuts is greater than an aggregate surface are of expandable portion(s) having cuts therethrough. In exemplary embodiments, each expandable portion 30 includes a plurality of cuts that allow the material to separate as the loop strip 21 or loop 22 expands in a direction primarily orthogonal to an orientation of the cuts. In some embodiments, the sheet substrate from which article 20 is cut can have elasticity (recovery toward an initial configuration after being stretched) to enhance compressive forces of loop strip 21 or loop 22 for bundling a plurality of items of a product 26 or for more securely holding the article 20 onto a product 26.

In an exemplary embodiment, each of the expandable cuts is provided in the form of a longitudinal slit. In exemplary embodiments, each cut of an expandable portion 30 is substantially parallel to all the other cuts of that expandable portion 30. In an exemplary embodiment, an expandable portion includes alternating perimeter cuts 32 and/or interior cuts 38. Referring to FIGS. 2-5, 11, 13 and 15, for example, each edge cut 32 extends to one edge 28, 36 of the article and each interior cut 38 does not extend to an edge 28, 36 of the article 20.

All descriptions with respect to one element also apply to the other similarly numbered elements unless stated otherwise. For ease of explanation, in the discussion of a particular embodiment of an element, a lowercase letter or apostrophe or double apostrophe may be used as a distinguishing mark. As labeled in FIGS. 1A and 2 with respect to article 20a, in an exemplary embodiment, each cut 32, 38 is aligned substantially parallel to a width orientation (W) of the article at its expandable portion 30. Expansion, lengthening or growth of the article 20 in an orthogonal length orientation (L) is accomplished by opening of the cuts 32, 38 so that an open length of space is achieved from the initial, substantially closed slit configurations of cuts 32, 38. The cuts 32, 38 of the illustrated expandable portions 30 are primarily provided as slit cuts through the sheet material, having a length aligned with orientation W but essentially no dimension aligned with orientation L. However, in other embodiments, the cut can be provided as holes or other shapes, including cuts with initial rectangular, elliptical, or other hole shapes.

The drawings show various embodiments of an article 20 formed from a band or strip of sheet material. In some embodiments, the article 20a, 20b, 20c, 20f in band or strip form includes opposed end edges 34 and opposed longitudinal edges 36. In some illustrated embodiments, these edges 34, 36 are configured in a rectangle, with linear and mutually parallel end edges 34 and orthogonally arranged, linear and mutually parallel longitudinal edges 36. However, article 20 can have other elongated shapes, including without limitation parallelogram, trapezoid, elliptical, and curved or serpentine strips, for example. Moreover, article 20 can have loop and tag configurations such as illustrated in FIGS. 1C, 1D and 11-18, for example.

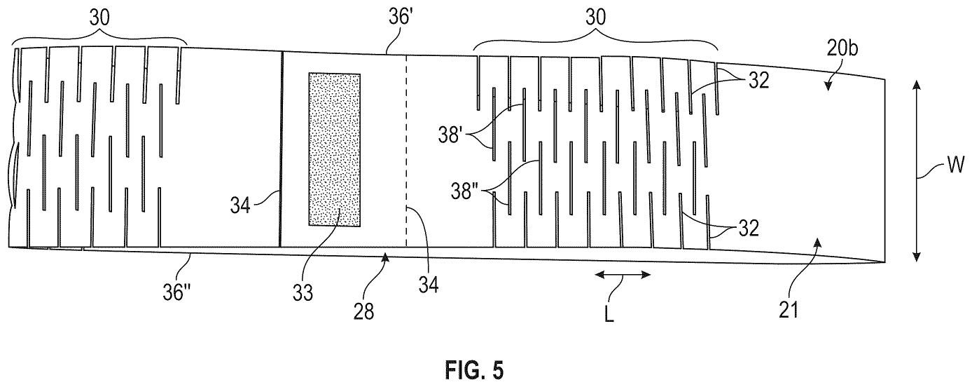

When the sheet article 20 itself is not cut with a hole or aperture 28 through the sheet, a loop strip 21 is formed with aperture 28 (for the receipt of a product item, as shown in FIGS. 10A and 10B, for example). In one method of loop formation, one end edge 34 is overlapped onto the opposite end edge 34 of the band and secured thereto at connection zone 33. The strip can be retained in a loop strip configuration by attaching the ends proximate edges 34 to each other so that they do not mutually separate in use. In FIG. 5, the bond area of connection zone 33 between end edges 34 of the article 20 is indicated by stippling. Suitable means for securing the ends of article proximate end edges 34 together include the use of adhesive or other bonding techniques relying on thermal or ultrasonic energy, for example. Such bonding can be performed during the manufacture of article 20. Examples of suitable adhesives include pressure sensitive adhesives (PSAs) (e.g., hot-melt PSAs), such as those based on acrylic monomers and polymers (e.g., bio-based acrylates), block copolymer rubber adhesives, silicone rubber adhesives, and the like, which may optionally include one or more additional tackifying resins.

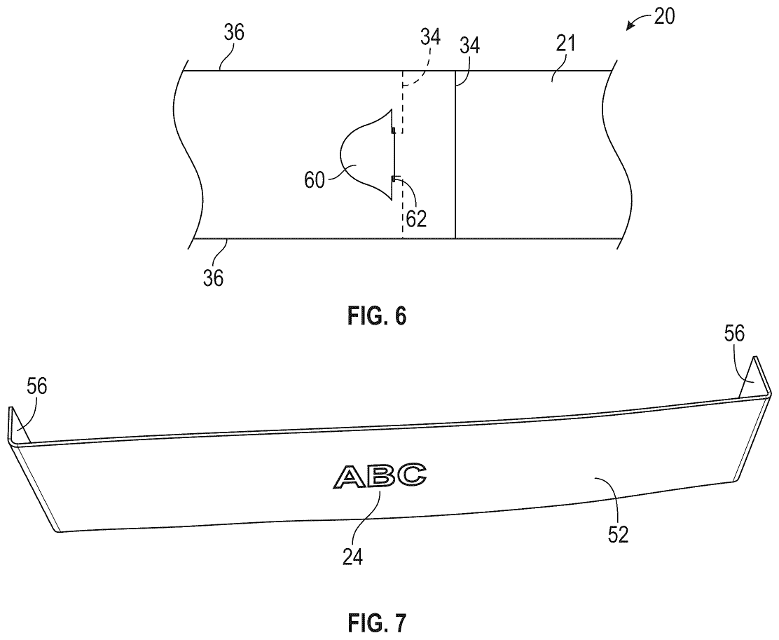

Alternatively, as shown in FIG. 4, in some embodiments, article 20 is provided with a patch of an adhesive layer 40, such as a pressure sensitive adhesive, protected by a removable release liner 42. Liner 42 may be fabricated from a paper and/or polymeric web (e.g., a polyolefin and/or polyethylene terephthalate web) coated with one or more release agents (e.g., a silicone release coating). Additionally, other attachment mechanisms can be used to secure the article in a loop such as tape, glue, a staple, a clip or a clamp, hook and loop fasteners, or a cooperating mechanical self-fastener such a barbed tab 60 and slot 62 (as shown in FIG. 6), for example. In these cases, the article 20 can be formed into loop strip 21 and secured in that configuration by a user after manufacture.

As shown in FIGS. 7-9, in another exemplary construction, article 20f is formed of a first portion 52 and a second portion 54. In an exemplary embodiment, first portion 52 is printed with indicia 24 to function as an information label. In an exemplary embodiment, the second portion 54 is provided with one of more expandable portions 30. In an exemplary embodiment, first portion 52 has a greater length than second portion 54, and ends of first portion 52 are folded to form tabs 56. To form article 20f, tabs 56 are bonded to uncut ends 58 of second portion 54. As shown in FIGS. 9, 10A and 10B, the aperture 28 of article 20f is stretched to encircle a product 26. In exemplary use applications, the loop band or strip 21 remains connected adjacent its bonded together ends and tabs despite tension forces in product-encircling direction L.

As illustrated, expandable portions 30 can be formed with different numbers and configurations of cuts 32, 38 to provide expandable portions of finely tuned functional (i.e., elongation, hold force, recovery, compliance, etc.) qualities, even though the sheet material of the article may be substantially non-stretchable. For example, article 20a of FIG. 2 has two expandable portions 30 (spaced apart along dimension L), each having 15 perimeter cuts 32 on each opposed longitudinal edge 36. Article 20b of FIGS. 3 and 5 has two expandable portions 30, each having eight perimeter cuts 32 on one longitudinal edge 36 and nine perimeter cuts 32 on the other longitudinal edge 36. Article 20c of FIG. 4 has three expandable portions 30, each having six perimeter cuts on each opposed longitudinal edge 36. In exemplary embodiments, the perimeter cuts 32 on one longitudinal edge 36 are slightly offset (in dimension L) from the perimeter cuts on the opposed longitudinal edge 36.

In an exemplary pattern of cuts in expandable portion 30, perimeter cuts 32 alternate with interior cuts 38 along length dimension L. Moreover, where several sets of interior cuts 38 are provided across a width orientation W, those interior cuts 38 alternate (i.e., are staggered) along an elongation direction (which in some cases is a length orientation) L between interior cuts 38′ proximate longitudinal edge 36′ and interior cuts 38″ proximate longitudinal edge 36″. These particularly labeled cuts are shown in FIGS. 3 and 5, though the description also applies to the other described articles 20. In the illustrated embodiments of articles 20a, 20b, and 20c, two sets of interior cuts 38′, 38″ are described; however, in another article that may have a greater width in the direction W, more sets of interior cuts may be used. In the illustrated embodiment, each interior cut 38′, 38″ is co-linearly aligned in the orientation W with an edge cut 32. There are more edge cuts 32 than interior cuts 38′, 38″, but this need not be the case.

While cuts 32, 38 are illustrated as being linear cuts oriented in direction W, it is also contemplated that the cuts can be provided as curvilinear or other shaped cuts and need not be exactly parallel to each other or direction W. Depending on the stiffness and other characteristics of the sheet material for article 20 and the degree of expansion desired for portion 30, the cuts can be modified in length, shape and spacing to provide the desired elongation, retention, and other performance properties of their respective expandable portion 30.

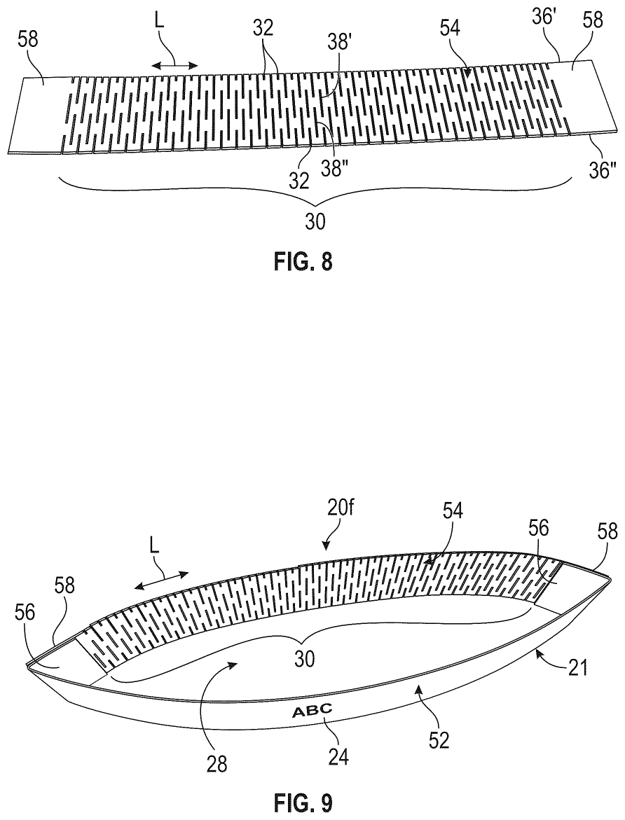

As shown in FIGS. 8 and 9, article 20f has a single long expandable portion 30. At any point along length dimension L, a series of cuts extending in width dimension W can have one or two perimeter cuts 32 on each opposed longitudinal edge 36. In an exemplary pattern of cuts in expandable portion 30, perimeter cuts 32 alternate with interior cuts 38 along length dimension L on edge 36″. However, perimeter cuts 32 are adjacent to each other (though alternating in length) along edge 36′. Where several sets of interior cuts 38 are provided across a width orientation W, those interior cuts 38 alternate (i.e., are staggered) along an elongation direction (which in some cases is a length orientation) L between interior cuts 38′ proximate longitudinal edge 36′ and interior cuts 38″ proximate longitudinal edge 36″. In an exemplary embodiment, the expandable portion 30 is positioned on less than half of a length (in dimension L) of article 20f so that when the article 20f is formed into a loop 21 as shown and placed around a product 26 (see FIGS. 10A and 10B) so that indicia 24 face a viewer, the expandable portion 30 is positioned toward a rear of the product 26 and is less visible to the viewer.

FIGS. 10A and 10B show article 20f formed into a loop strip 21 as in FIG. 9, having an aperture 28 for receipt of a portion of product 26 therethrough. In this illustrative method of use of article 20a, the product 26 is a bunch of bananas. The expandable portion 30 allows for the accommodation of the increase in circumferential length by opening of the cuts 32, 38 as needed. The strength of the sheet material surrounding the interior cuts 38 allows the article 20 to maintain a compressive force on the product 26, which is useful for maintaining a plurality of products in a bundle. Thus, in some embodiments, article 20 is useful not only for labeling the product 26 with indicia 24, but also serving a bundling or retention function for keeping multiple such products together (such as the bananas of a bunch or a bundle of green onions, for example, for storage, transport, distribution or use). Moreover, expansion of expandable portion 30 may or may not be uniform along its entire length dimension L; for example, in FIG. 10B, the rear part of expandable portion 30 has changed in length more than the front parts of expandable portion 30 shown in FIG. 10A (in the rear part of expandable portion 30, the cuts 32, 38 exhibit greater spread in elongation direction L).

As shown in FIGS. 1C, 1D and 11-18, articles 20d, 20e, 20g, 20h and 20i are formed to define an integral structure of loop 22 and tag 48. In an exemplary embodiment of article 20d of FIGS. 1C and 11-12B, neck 50 is disposed at a juncture of loop 22 and tag 48 and has a narrower dimension in direction L than a parallel dimension of loop 22; moreover, neck 50 has a narrower dimension in direction L than a parallel dimension of tag 48. Article 20d has a relatively smaller expandable portion 30 including three perimeter cuts 32p on perimeter edge 36; three aperture cuts 32a at aperture 28 of loop 22; and two interior cuts 38. In this example, the perimeter cuts 32p and aperture cuts 32a on opposite sides of loop 22 are aligned along direction L. The interior cuts 38 are space apart and staggered in the direction L relative to the perimeter cuts 32p and aperture cuts 32a. Indicia 24 can be provided anywhere on article 20d but are most commonly positioned on one or both major surfaces (front or rear) of tag 48.

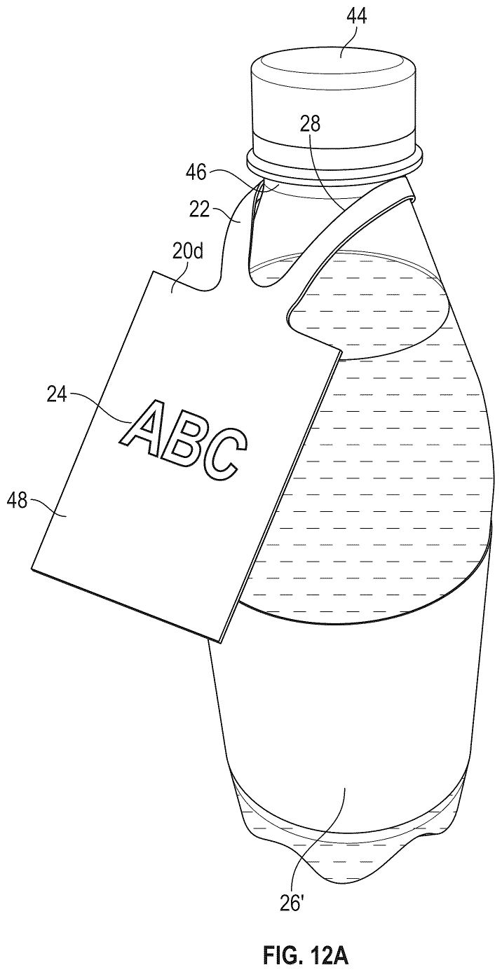

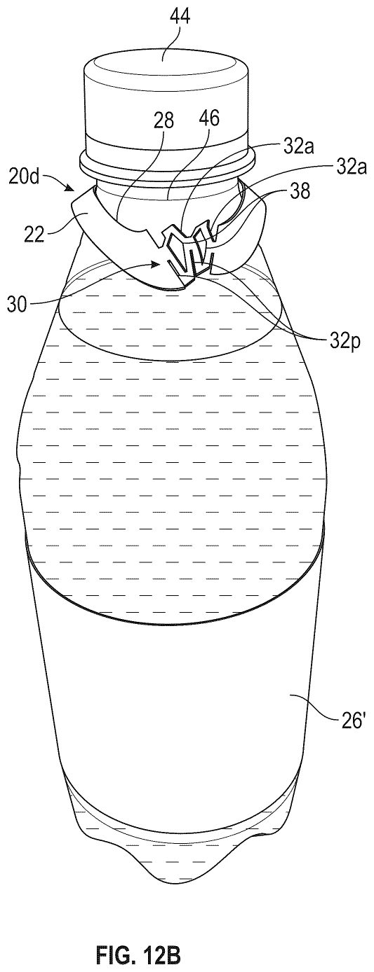

FIGS. 12A and 12B are front and rear views, respectively, of article 20d with a different configuration of product 26′. In these illustrations, the product 26′ is a beverage bottle having a cap 44 that is inserted through aperture 28 of loop 22. In this implementation, a diameter of cap 44 is greater than a size of aperture 28 near expandable portion 30. Thus, the expandable portion 30 has lengthened in direction L (labeled in FIG. 11) to fit past cap 44 and onto neck 46. Additionally, the cuts 32, 38 do not necessarily open to the same extent along the entire expandable portion 30. In an exemplary embodiment, once article 20d is inserted onto the bottle so loop 22 is past cap 44, the expandable portion 30 contracts to affix article 20d to product 26′.

As shown in FIGS. 1D, 13 and 14, article 20e is formed to define an integral structure of loop 22 and tag 48. In an exemplary embodiment, neck 50 is disposed at a juncture of loop 22 and tag 48, has a narrower dimension in direction W than a dimension of loop 22, and has a narrower dimension in direction W than a dimension of tab 48. Neck 50 serves to isolate tag 48 from the tension forces experienced in the stretching of loop 22 at expandable portions 30. Article 20e has two expandable portions 30, each including five cuts 32p, 32a on each opposed perimeter edge 36 and aperture edge 28 of loop 22, and four interior cuts 38. In this example, the perimeter cuts 32p and aperture cuts 32a on opposite sides of loop 22 are aligned along direction L. In one embodiment, each aperture cut 32a is also co-linear with one of the perimeter cuts 32p. The interior cuts 38 are spaced apart and staggered in the direction L relative to the perimeter cuts 32p and aperture cuts 32a. Indicia 24 can be provided anywhere on article 20e but are most commonly positioned on one or both major surfaces (front or rear) of tag 48. While not shown, having an uncut portion of loop 22 between the expandable portions 30 also provides a suitable location for the provision on indicia 24 on loop 22.

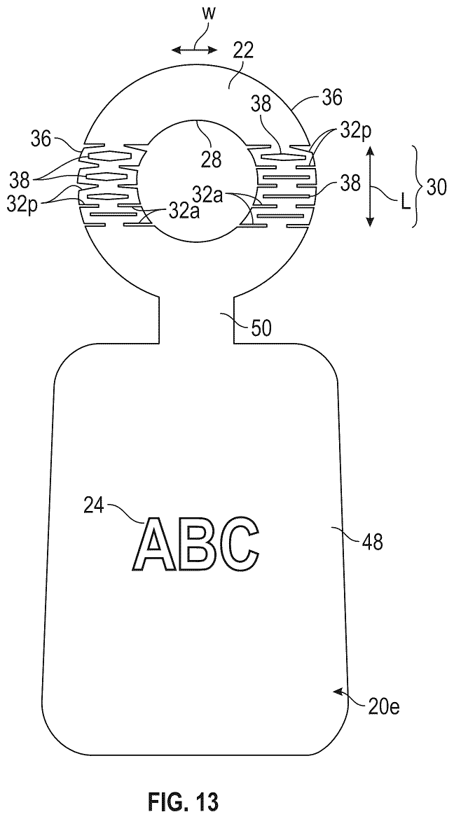

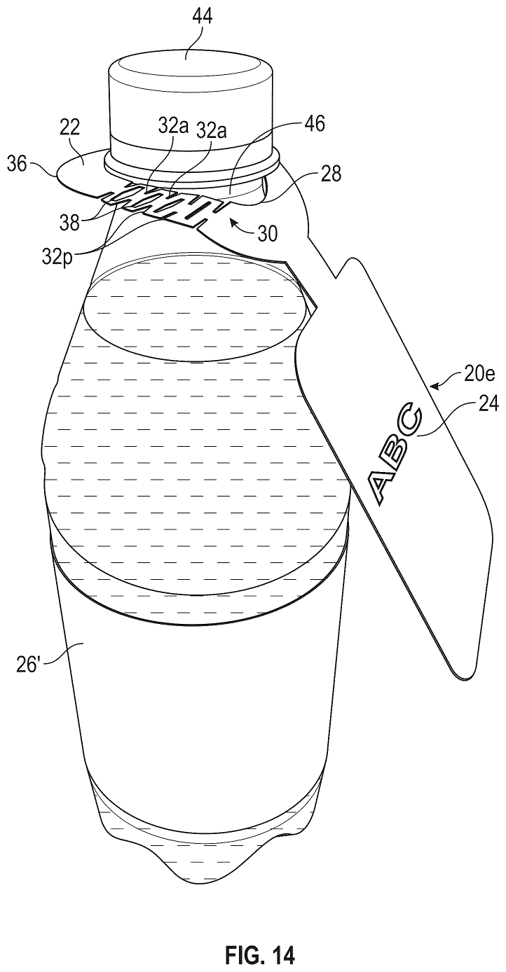

FIG. 14 is a side perspective view of the product 26′ with article 20e. In some cases, as illustrated in FIG. 13, for example, the product 26′ configured as a bottle has a cap 44 that is larger in dimension than a neck 46 of the product 26′. Thus, expandable portion 30 increases in dimension along length orientation L to allow aperture 28 to fit over and around cap 44. The expandable portion 30 can contract around the neck 46 to thereby secure article 20e onto the product 26′ to display indicia 24 thereon. The cuts 32, 38 do not necessarily open to the same extent along the entire expandable portion 30. Moreover, cuts 32, 38 on one expandable portion 30 of an article 20 may open to different extents compared to cuts 32, 38 on another expandable portion 30 of an article 20.

In this disclosure, the orientations of direction lines L and W pertain to the cut structures of each expandable portion 30 rather than the overall geometry of the article 20. For example, with respect to FIG. 11, an elongation direction L of the expandable portion 30 is not necessarily aligned with a length direction of the article 20d; moreover, a width direction W of the expansion portion 30 pertains to a width orientation of the loop 22 at a location of expansion portion 30 and is not necessarily aligned with a width direction of the article 20d.

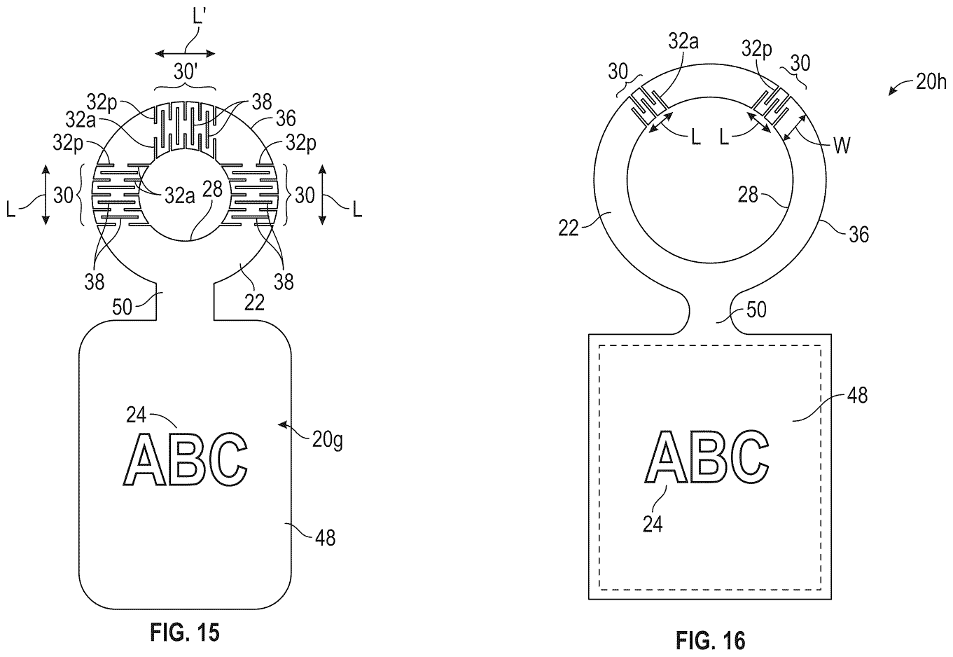

In some of the illustrated examples, all of the expandable portions 30 of any single article 20a, 20b, 20c, 20d, 20e, 20f are oriented consistently. For example, in FIGS. 2, 3 and 4, all expandable portions 30 of any article 20a, 20b, 20c have vertically oriented (W-oriented) cuts 32, 38 configured to expand horizontally (L-oriented) as labeled in the drawings. In FIG. 13, both expandable portions 30 of article 20e have horizontally oriented (W-oriented) cuts 32, 38 configured to expand vertically (L-oriented) as oriented in the drawings. However, this need not be the case. Referring to FIG. 15, article 20g has a single (top) expansion portion 30′ having a horizontal elongation direction L′ while two expansion portions 30 disposed on left and right sides of loop 22 have a substantially orthogonal expansion direction L.

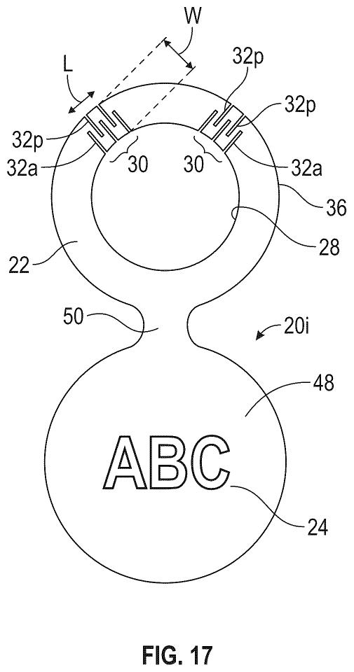

In other embodiments, cuts 32, 38 need not be oriented vertically or horizontally with respect to primary edges of an article; for example, cuts 32, 38 could be oriented substantially radially around a circular loop 22 (as shown in articles 20h, 20i of FIGS. 16 and 17, for example). While the cuts 32 of an expansion portion 30 are generally parallel to each other, they could be oriented along respective radii of the loop 22. Although expandable loop 22 is illustrated in FIGS. 1C, 1D and 11-18 with particular loop shapes, these configurations are not limiting. For example, expandable loop 22 can be oval, round or have an irregular shape, depending upon the desired application and characteristics of the sheet material (e.g., stiffness, flexibility, resiliency, etc.), the width of the loop band, the size of open area 28, and the configuration of product 26, among other factors. Orienting the longitudinal extent of each of the cuts 32, 38 substantially radially about a loop 22 contributes to even expansion along the elongation direction L and preservation of the strength and integrity of surrounding uncut portions of loop 22.

As shown in FIG. 16, article 20h is formed to define an integral structure of loop 22 and tag 48. In an exemplary embodiment, neck 50 is disposed at a juncture of loop 22 and tag 48, has a narrower width than a width of loop 22, and has a narrower width than a width of tag 48. Article 20h has two expandable portions 30, each including five alternating perimeter cuts 32p and aperture cuts 32a on loop 22; there are no interior cuts. In an exemplary embodiment, the expandable portions 30 are positioned toward a rear of loop 22 (spaced from tag 48) so that when article 20h is disposed with tag 48 on a front of a product 26′, the expandable portions 30 are positioned toward a rear of the product 26′ and are less visible to a viewer. In this example, the perimeter cuts 32p and aperture cuts 32a on opposite sides of loop 22 are aligned in approximate radial directions with respect to a center of the circular aperture 28. Indicia 24 can be provided anywhere on article 20h but are most commonly positioned on one or both major surfaces (front or rear) of tag 48. In this embodiment, tag 48 is configured with a rectangular outer perimeter shape.

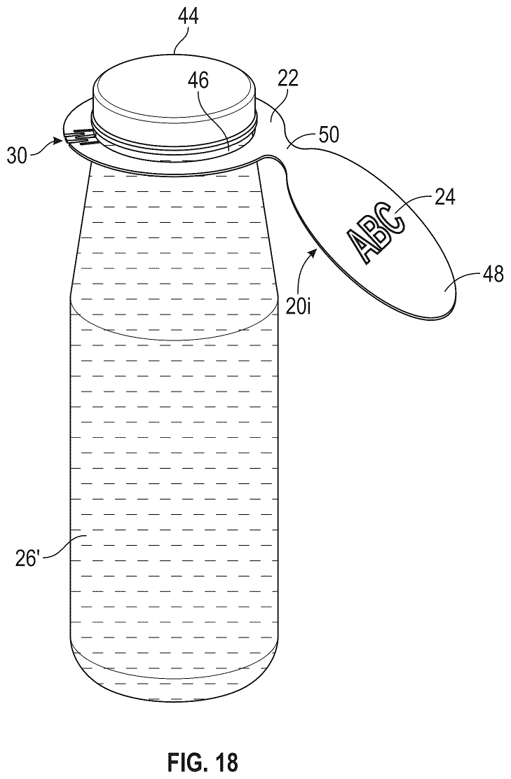

As shown in FIG. 17, article 20i is formed to define an integral structure of loop 22 and tag 48. In an exemplary embodiment, neck 50 is disposed at a juncture of loop 22 and tag 48, has a narrower width than a width of loop 22, and has a narrower width than a width of tag 48. Article 20i has two expandable portions 30, each including five alternating perimeter cuts 32p and aperture cuts 32a of loop 22; there are no interior cuts. In an exemplary embodiment, the expandable portions 30 are positioned toward a rear of loop 22 (spaced from tag 48) so that when article 20i is disposed with tag 48 on a front of a product 26′ (see FIG. 18), the expandable portions 30 are positioned toward a rear of the product 26′ and are less visible to a viewer. In this example, the perimeter cuts 32p and aperture cuts 32a on opposite sides of loop 22 are aligned in approximate radial directions with respect to a center of the circular aperture 28. Indicia 24 can be provided anywhere on article 20i but are most commonly positioned on one or both major surfaces (front or rear) of tag 48. In this embodiment, tag 48 is configured with a circular outer perimeter shape. It is to be understood that tag 48 may have any outer perimeter shape.

Exemplary embodiments of the described articles 20 allow for tagging and labeling functions on an article that is able to expand in at least one dimension without using stretchy or elastic materials to do so. Because articles 20 are formed of a cut unitary sheet of material, production is economical. Where the sheet material is formed of a composition that is recyclable, the unitary composition also allows for ease of recycling of the articles. Moreover, the expandable portions 30 can be configured to allow for breaking at the cuts 32, 38 to provide for an easily detachable article upon the introduction of a purposefully applied force. Such embodiments may be useful for attaching indicia 24 as a coupon to be yanked off the product 26 and presented to a cashier upon purchase, for example. Moreover, other items such as sample products, for example, can be attached to articles 20 to be coupled with the primary product 26 and detached purposefully by a consumer by breaking expandable portion 30 (achieved by applying sufficient tensile force along dimension L to tear the sheet material adjacent the cuts 32, 38). Additionally, the cut structure could even be designed to rupture at a specific location along the expandable portion, depending on the form of the cuts.

Elongation of expandable portion 30 also allows aperture 28 to accommodate irregular shapes of products 26. While particular embodiments of articles 20 are illustrated, these teachings can be applied to articles having different cut matrices, material types and thicknesses and overall tag geometries. For example, while the tag and loop articles 20d, 20e, 20g, 20h and 20i are not illustrated with more than one row of interior cuts 38, it is to be understood that such a tag and loop article having a wide or thick loop 22 can have more cuts and rows of cuts in their expandable portions 30 than particularly illustrated, such as those described with reference to band articles 20a, 20b, 20c and 20f, for example. Different numbers of expandable portion 30 can be provided about a product surrounding aperture 28, and each expandable portion 30 can have different numbers, spacings and/or lengths of perimeter cuts 32 and interior cuts 38. Thus, the expandable portions 30 of a single article 20 can be different from each other. While specific illustrations of expandable portion 30 have been shown, it is contemplated that different assemblies of cuts can be used. Moreover, in an expandable portion 30, perimeter cuts 32 needs not all be same length, and interior cuts 38 need not have a common length. Moreover, while some expandable portions 30 as illustrated have cuts that are balanced in the orientations W and L, configurations can be used in which cuts on one side of an expandable portion can be longer or spaced differently than cuts on another side. For example, an expandable portion 30 can be configured to provide an asymmetrical placement on a product 26 to enhance visibility of the indicia 24 by having a portion of the article 20 stick out from the product 26.

Additionally, changes in the configuration of neck 50 can also be optimized for positioning article 20 on a product 26′. For example, articles 20e, 20g, 20h, 20i with relatively narrow and longer necks 50 can allow tag 48 to hang with an orientation that is generally independent of an orientation of loop 22 on product 26′. In contrast, article 20d with a relatively wide and shorter neck 50 can be used where it is desirable to influence an orientation of tag 48 by the placement of loop 22 on product 26′ (such as to make tag 48 protrude from the product 26′ in a particular way for enhanced visibility in a display, for example). Moreover, while the articles 20 are generally symmetrical as illustrated, they could be asymmetrical. In one embodiment of article 20, a neck 50 could be disposed on only a left side of a loop 22 and tag 28 of an article 20, for example.

Especially in those instances where the product 26 being tagged has an irregular shape, or if it is desired to bind several product pieces together, the loop strip 21 or loop 22 around aperture 28 should be resilient enough hold article 20 to the product 26 (around an article or a portion thereof, e.g., a watermelon, bunch of asparagus, container or other item) while allowing article 20 to maintain its labeling function. In many cases, the article 20 displays indicia 24, which may include not only human detectable indicia, but also machine detectable indicia (e.g., a UPC bar code). Provision of indicia 24, such as by printing, embossing, inlaying, or engraving, for example, can be accomplished before or after article 20 is provided to a consumer. For example, article 20 can be printed or written on by the user to provide specific information such as a pick date, facility number, batch or lot identifier or expiration date, for example.

As shown in FIGS. 10A and 10B, in some use applications, when the article 20 is secured to the product 26, the circumference of aperture 28 is larger than it is when the article 20 is sitting loosely (see FIG. 9). In other words, the loop strip 21 or loop 22 of article 20 expands (i.e., elongates in dimension L) to accommodate the product 26 and then remains lengthened to some extent while engaged about the product 26. Articles 20 such as those described here can be constructed to accommodate products and items of any size and shape. While the loop and tag variations of article 20 are illustrated in use with a product 26′ configured as a bottle, it is contemplated that any configuration of article 20 can be used with any configuration of product 26. The effective circumference of the opening or aperture 28 can be selectively constructed to accommodate products 26 of different sizes and shapes. Suitable applications for articles 20 described herein include, but certainly are not limited to, the wrapping and/or bundling and labeling of produce (e.g., watermelon, cantaloupe, etc.) and the wrapping and labeling of clamshell containers (such as take-home boxes from restaurants or other such containers that are hinged on one side). Smaller versions (i.e., with smaller band or loop opening 28) can apply to smaller items (such as a bunch of asparagus, for example).

Web-based processing may be used for the manufacture of articles 20 from a standpoint of economy, although batch processing and conveyor processing with indexing from station to station for specific operations can be useful (especially for uniquely designed or shaped articles). A web of article sheet material (which may be polystyrene) is optionally given a surface treatment such as a corona surface treatment to enhance printing ink adhesion. The web can be repetitively printed with informational matter as intended for indicia 24 on each article 20 to be later formed (such as cut) from the web. The web is processed to ultimately define individual articles 20.

In some cases, individual articles 20 are fully cut from the web sheet. In other embodiments, the web includes weakened separation lines between adjacent ruptureably connected articles 20. Configurations of weakened separation lines include, for example, score lines, cut lines of full or partial depth, perforations, and other mechanisms for forming a rupturable line or contour of weakness connecting adjacent articles 20. Cutting of articles 20 from the sheet of web material may be accomplished by any known means, including the use of dies and lasers, for example.

Although the edges 34, 36 are illustrated in some embodiments as linear and parallel, it is contemplated that any perimeter shapes of articles 20 and any aperture shapes of loop 22 can be used. Moreover, a strip of connected articles 20 can be spooled into roll form, and then individual articles 20 can be torn off of the roll as desired at the separation lines.

Many different sheet materials can be utilized in the implementation of the articles 20 described herein. Examples of suitable materials for articles 20 include films of polyethylene terephthalate, polyethylene, polypropylene (e.g., oriented polypropylene), and combinations thereof. In some embodiments, tag portion 14 is formed at least in part from biodegradable, degradable, or recyclable materials (e.g., one or more polypropylene and/or styrene-based materials), and may be suitable for receiving printed information (such as human or machine-readable indicia). Additional examples of suitable materials for articles 20 include those recited for the tag portion in King et al., U.S. Pat. No. 7,836,622; Ludlow et al., U.S. Pat. No. 7,281,345; and Ludlow et al., International Application Publication No. WO07/084119. Suitable material substrates include, for example and without limitation, (1) 10 mil thick Artisyn™ synthetic paper, product no. UAR 100, available from Protect-All Print Media, Inc., Darrien, Wisconsin, at a width of 8.5 inches; (2) 7.5 mil thick Teslin™ synthetic paper, 7 mil SP 700, available from Technicote, Inc., Cuyahoga Falls, Ohio (made by PPG Industries, Pittsburgh, Pennsylvania), at a width of 8.5 inches; or (3) 4 mil thick PET Tairilin polyester film, product nos. CH284, CH885 and Cy18, available from Nan Ya Plastics Corporation USA of Wharton, Texas, at widths of 5-15 inches. In addition, in some applications, it may be desirable to add compatible additives to the sheet material, to achieve such ends as coloration, opacity, print durability, resistance to degradation on exposure to some environments (e.g., sunlight), improved impact properties and adhesion properties, luminescence, and scent impregnation, for example.

Although the subject of this disclosure has been described with reference to several embodiments, workers skilled in the art will recognize that changes may be made in form and detail without departing from the scope of the disclosure. In addition, any feature disclosed with respect to one embodiment may be included in another embodiment, and vice-versa.

1. An article formed of a sheet material, the article comprising:
a tag; and
a loop surrounding an aperture, the loop:
being connected to the tag;
comprising a perimeter edge and an aperture edge; and
comprising an expandable portion comprising:
a plurality of perimeter cuts, each of the perimeter cuts extending to the perimeter edge; and
a plurality of aperture cuts, each of the aperture cuts extending to the aperture edge.

2. The article of claim 1, wherein the loop comprises a first interior cut, wherein:
the first interior cut does not extend to either of the perimeter edge or the aperture edge; and
the first interior cut is disposed at least partially between two adjacent perimeter cuts in an elongation direction of the expandable portion.

3. The article of claim 2, wherein at least one of the plurality of perimeter cuts is substantially parallel to the first interior cut.

4. The article of claim 2 comprising a second interior cut spaced from the first interior cut along the elongation direction.

5. The article of claim 4, wherein the second interior cut is co-linear with at least one of the perimeter cuts and is orthogonal to the elongation direction.

6. The article of claim 4, wherein:
the first interior cut is one of a plurality of first interior cuts; and
the second interior cut is positioned at least partially between the two of the plurality of first interior cuts in the elongation direction.

7. The article of claim 4, wherein the second interior cut is one of a plurality of second interior cuts.

8. The article of claim 1 comprising indicia disposed on the tag.

9. The article of claim 1 comprising a neck connecting the loop and the tag, wherein a width of the neck is less than a width of the loop and less than a width of the tag.

10. The article of claim 1, wherein the expandable portion is one of a plurality of expandable portions.

11. The article of claim 10, wherein a first expandable portion and a second expandable portion of the plurality of expandable portions have parallel elongation directions.

12. The article of claim 10, wherein a first expandable portion and a second expandable portion of the plurality of expandable portions have perpendicular elongation directions.

13. The article of claim 10, wherein a first expandable portion and a second expandable portion of the plurality of expandable portions have mutually angled elongation directions.

14. The article of claim 1, wherein the aperture is configured as a circle.

15. The article of claim 14, wherein at least one of the plurality of perimeter cuts or the plurality of aperture cuts is positioned along a radius of the circle.
